(19) United States
(12) Patent Application Publication
(10) Pub. No.: US 2022/0254364 A1
(43) Pub. Date: Aug. 11, 2022

(54) METHOD AND APPARATUS FOR NOISE REDUCTION OF FULL-BAND SIGNAL

(71) Applicant: LINE Plus Corporation, Seongnam-si (KR)

(72) Inventor: Ki Jun KIM, Seongnam-si (KR)

(73) Assignee: LINE Plus Corporation, Seongnam-si (KR)

(21) Appl. No.: 17/665,939

(22) Filed: Feb. 7, 2022

(30) Foreign Application Priority Data
Feb. 8, 2021 (KR) 10-2021-0017784

(51) Int. Cl. G10L 21/0232; G10L 25/21; G10L 25/18; H04M 7/00

(52) U.S. Cl. CPC G10L 21/0232; H04M 7/0072; G10L 25/18; G10L 25/21

(57) ABSTRACT

Disclosed is a method and apparatus for noise reduction of a full-band signal. A noise reduction method includes down-sampling a first signal of a first band to obtain a first signal of a second band, the first signal of the first band being an input speech signal including noise, and the second band being a lower portion of the first band, removing noise from the first signal of the second band to obtain a second signal of the second band, estimating band-by-band energy of a third band based on the second signal of the second band to obtain estimated band-by-band energy, the third band being a portion of the first band remaining after excluding the second band, and generating a signal from which noise of the third band is removed based on the estimated band-by-band energy.

### CROSS-REFERENCE TO RELATED APPLICATION(S)

This U.S. non-provisional application and claims the benefit of priority under 35 U.S.C. § 119 to Korean Patent Application No. 10-2021-0017784, filed Feb. 8, 2021, the entire contents of which are incorporated herein by reference in their entirety.

### TECHNICAL FIELD

Some example embodiments relate to a method and apparatus for noise reduction of a full-band signal.

### BACKGROUND

Currently, with the increasing interest in Internet calls, such as voice over Internet protocol (VoIP), and interest in development and provision of content using other speech/sound signals, interest in technology for removing noise from speech signals is also increasing.

The existing noise reduction technology using deep learning, for example, is developed mainly for signals having a sampling rate of 16 kHz. In the case of expanding such technology to a signal of a full band (a sampling rate of 48 kHz and a maximum, or highest, frequency of 24 kHz), a section of (e.g., size of) an input signal increases and a computation amount increases accordingly, which increases the difficulty in implementing services, such as a VoIP service that operate in real time.

The foregoing information is simply provided for understanding only and may include content that does not form a part of the related art and may not include what the related art may present to those skilled in the art.

### SUMMARY

Some example embodiments may provide a noise reduction method and apparatus that may remove noise from a signal of a full band (a sampling rate of 48 kHz and a maximum, or highest, frequency of 24 kHz) using fewer computations.

According to an aspect of some example embodiments, there is provided a noise reduction method performed by a computer device including at least one processor, the noise reduction method including down-sampling, by the at least one processor, a first signal of a first band to obtain a first signal of a second band, the first signal of the first band being an input speech signal including noise, and the second band being a lower portion of the first band, removing, by the at least one processor, noise from the first signal of the second band to obtain a second signal of the second band, estimating, by the at least one processor, band-by-band energy of a third band based on the second signal of the second band to obtain estimated band-by-band energy, the third band being a portion of the first band remaining after excluding the second band, and generating, by the at least one processor, a signal from which noise of the third band is removed based on the estimated band-by-band energy.

The estimating of the band-by-band energy of the third band may include calculating a magnitude value for a frequency coefficient by applying a fast Fourier transform (FFT) to the second signal of the second band to obtain a calculated magnitude value, and estimating the band-by-band energy of the third band using the calculated magnitude value and a deep learning model.

The deep learning model may be trained by using a reference magnitude value for a reference signal of the second band as input data and using a reference estimated band-by-band energy of the third band as a label, the deep learning model being trained to output the reference estimated band-by-band energy when the reference magnitude value is input.

The deep learning model may be trained to receive 256 magnitude values as input and to output 16 band-by-band energy magnitudes.

The generating of the signal from which the noise of the third band is removed may include generating a signal of the third band by removing the first signal of the second band from the first signal of the first band using a high-pass filter, calculating a frequency coefficient by applying an FFT to the signal of the third band, calculating band-by-band energy of the signal of the third band to obtain calculated band-by-band energy, and calculating the signal from which the noise of the third band is removed based on the estimated band-by-band energy, the calculated band-by-band energy, and the frequency coefficient.

The calculating of the signal from which the noise of the third band is removed may include generating a signal from which noise is removed for each band by multiplying the frequency coefficient to a ratio of the calculated band-by-band energy to the estimated band-by-band energy.

The noise reduction method may further include up-sampling, by the at least one processor, the second signal of the second band to obtain a second signal of the first band from which the noise of the second band is removed, and generating, by the at least one processor, a restored speech signal by mixing the second signal of the first band and the signal from which the noise of the third band is removed.

The first band may include a frequency band of a corresponding signal having a sampling rate of 48 kHz, the second band includes a frequency band from 0 to less than 8 kHz, and the third band includes a frequency band from 8 kHz to 24 kHz or less.

The removing of the noise from the first signal of the second band may inputting the first signal of the second band to a first network to obtain a first speech signal in which a phase is restored and noise is removed, the first network being a u-net structure trained to infer noise-removed speech in a time domain, applying a first window to the first speech signal, acquiring a magnitude signal and a phase signal by performing an FFT on the first speech signal to which the first window is applied, inputting the magnitude signal to a second network to acquire a mask. the second network being a u-net structure trained to estimate the mask, applying the mask to the magnitude signal to obtain a masked magnitude signal, generating a second speech signal from which noise is removed by performing an inverse fast Fourier transform (IFFT) on the first speech signal to which the first window is applied using the masked magnitude signal t and the phase signal, and applying a second window to the second speech signal. According to some example embodiments, the noise reduction method may further include generating a restored speech signal based on the signal from which noise of the third band is removed, and performing one of transmitting the restored speech signal to another device, vibrating air to output an audio signal based on the restored speech signal using a speaker, or storing the restored speech signal. According to some example embodiments, the input speech signal may be a Voice over Internet Protocol (VoIP) signal.

According to an aspect of some example embodiments, there is provided a non-transitory computer-readable record medium storing an instruction that, when executed by at least one processor included in a computer device, causes the computer device to perform the method.

According to an aspect of some example embodiments, there is provided a computer device including at least one processor configured to execute a computer-readable instruction to down-sample a first signal of a first band to obtain a first signal of a second band, the first signal of the first band being an input speech signal including noise, and the second band being a lower portion of the first band, remove noise from the first signal of the second band to obtain a second signal of the second band, estimate band-by-band energy of a third band based on the second signal of the second band to obtain estimated band-by-band energy, the third band being a portion of the first band remaining after excluding the second band, and generate a signal from which noise of the third band is removed based on the estimated band-by-band energy.

According to some example embodiments, it is possible to remove noise from a signal of a full band (a sampling rate of 48 kHz and a maximum (or highest) frequency of 24 kHz) using fewer computations.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a computer device according to some example embodiments;

FIG. 2 is a diagram illustrating an example of a noise reduction process according to some example embodiments;

FIG. 3 illustrates an example of a deep learning model according to some example embodiments;

FIG. 4 illustrates an example of a structure of a network that infers clean energy in a frequency band of 8˜24 kHz according to some example embodiments;

FIG. 5 illustrates an example of a process of removing noise from a signal of a low band (a frequency band of 0 to 8 kHz) according to some example embodiments;

FIGS. 6 and 7 illustrate examples of a network in a u-net structure according to some example embodiments;

FIG. 8 is a flowchart illustrating an example of a noise reduction method according to some example embodiments; and

FIG. 9 is a flowchart illustrating an example of a process of removing noise from a signal of a low band according to some example embodiments.

### DETAILED DESCRIPTION

Some example embodiments will be described in detail with reference to the accompanying drawings. Some example embodiments, however, may be embodied in various different forms, and should not be construed as being limited to only the illustrated examples. Rather, the illustrated examples are provided so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as, or a similar meaning to, that commonly understood by one of ordinary skill in the art to which some example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned herein. Examples of program code include both machine code produced by a compiler and higher-level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, some example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings. Like reference numerals in each drawing refer to like components throughout.

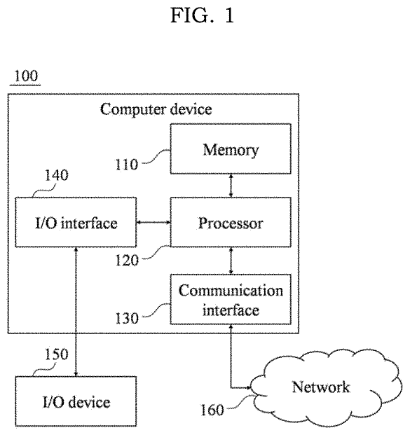

FIG. 1 is a diagram illustrating an example of a computer device according to some example embodiments. Referring to FIG. 1, a computer device 100 may include a memory 110, a processor 120, a communication interface 130, and/or an input/output (I/O) interface 140. The memory 110 may include a permanent mass storage device, such as a random access memory (RAM), a read only memory (ROM), and/or a disk drive, as a non-transitory computer-readable record medium. The permanent mass storage device, such as the ROM and/or the disk drive, may be included in the computer device 100 as a permanent storage device separate from the memory 110. Also, an OS and/or at least one program code may be stored in the memory 110. Such software components may be loaded to the memory 110 from another non-transitory computer-readable record medium separate from the memory 110. The other non-transitory computer-readable record medium may include a non-transitory computer-readable record medium, for example, a floppy drive, a disk, a tape, a DVD/CD-ROM drive, a memory card, etc. According to some example embodiments, software components may be loaded to the memory 110 through the communication interface 130, instead of the non-transitory computer-readable record medium. For example, the software components may be loaded to the memory 110 of the computer device 100 based on a computer program installed by files received over a network 160.

The processor 120 may be configured to process instructions of a computer program by performing basic arithmetic operations, logic operations, and/or I/O operations. The computer-readable instructions may be provided from the memory 110 or the communication interface 130 to the processor 120. For example, the processor 120 may be configured to execute received instructions in response to a program code stored in a storage device, such as the memory 110.

The communication interface 130 may provide a function for communication between the computer device 100 and another device. For example, the processor 120 of the computer device 100 may forward a request or an instruction created based on a program code stored in the storage device such as the memory 110, data, and/or a file, to other devices over the network 160 under control of the communication interface 130. Inversely, a signal, an instruction, data, a file, etc., from another device may be received at the computer device 100 through the communication interface 130 of the computer device 100. For example, a signal, an instruction, data, etc., received through the communication interface 130 may be forwarded to the processor 120 or the memory 110, and a file, etc., may be stored in a storage medium, for example, the permanent storage device, further includable in the computer device 100.

The I/O interface 140 may be a device used for interface with an I/O device 150 (e.g., an input device and/or an output device). For example, an input device may include a device, such as a microphone, a keyboard, a mouse, etc., and an output device may include a device, such as a display, a speaker, etc. As another example, the I/O interface 140 may be a device for interfacing with an apparatus in which an input function and an output function are integrated into a single function, such as a touchscreen. The I/O device 150 may be configured as a single device with the computer device 100.

According to some example embodiments, the computer device 100 may include a number of components greater than or less than a number of components shown in FIG. 1. However, some components according to the related art are not illustrated in detail. For example, the computer device 100 may include at least a portion of the I/O device 150, or may further include other components, for example, a transceiver, a database (DB), etc.

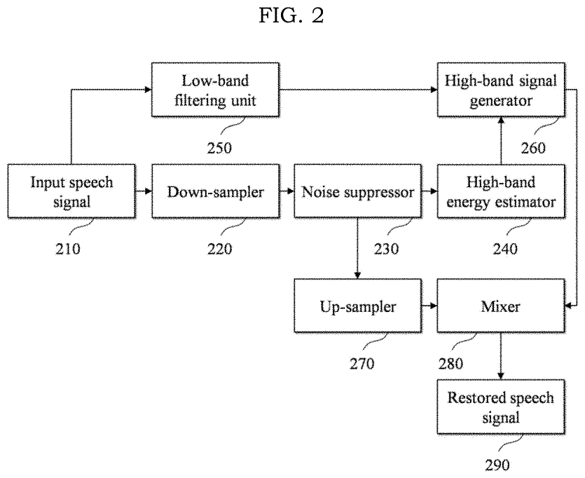

FIG. 2 illustrates an example of a noise reduction process according to some example embodiments. A process of acquiring, from an input speech signal 210, a restored speech signal 290 in which noise is removed is described with reference to FIG. 2. A down-sampler 220, a noise suppressor 230, a high-band energy estimator 240, a low-band filtering unit 250, a high-band signal generator 260, an up-sampler 270, and/or a mixer 280 of FIG. 2 may be functional expressions of operations for the processor 120 of the computer device 100 to acquire the restored speech signal 290 by removing noise from the input speech signal 210 under control of a computer program. According to some example embodiments, the input speech signal 210 is a VoIP signal.

The input speech signal 210 may have, for example, a sampling rate of 48 kHz and may be a signal that is input based on a frame unit for a real-time operation. A size of each frame may be 30 ms (1440 samples) and a hop size may be 15 ms (720 samples and 50% overlap).

The down-sampler 220 may generate a signal with a sampling rate of 16 kHz by down-sampling the input speech signal 210 with a sampling rate of 48 kHz. The generated signal with the sampling rate of 16 kHz may have a frame size of 30 ms (480 samples) and may have a hop size of 15 ms (240 samples and 50% overlap).

The noise suppressor 230 may remove noise from a signal of a low band (a frequency band of 0˜8 kHz or a frequency band of less than 8 kHz). That is, the noise suppressor 230 may generate a clean low-band signal by receiving the signal of 16 kHz generated by the down-sampler 220 and by removing noise from the signal. Further description related to the noise suppressor 230 is made below. The term “clean” used herein may represent a state in which noise is absent or removed (or lessened).

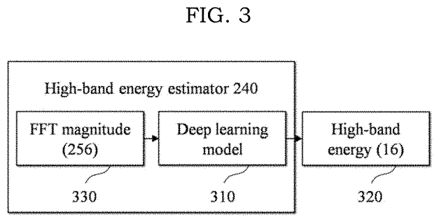

The high-band energy estimator 240 may estimate high-band energy of a high band (a frequency band of 8˜24 kHz) based on a signal from which noise is removed by the noise suppressor 230 and a deep learning model. A process of estimating high-band energy using the deep learning model is further described with reference to FIG. 3.

The low-band filtering unit 250 may remove a signal of a low band (a frequency band of 0˜8 kHz) from the input speech signal 210 to adjust band-by-band energy for a signal. For example, the low-band filtering unit 250 may remove a low-band signal by applying an 8-kHz high pass filter to the input speech signal 210.

The high-band signal generator 260 may calculate a frequency coefficient S(f) and may calculate band-by-band energy (hereinafter, ‘NE’) by applying a 2048-point-fast Fourier transform (FFT) to a high-band signal including noise that is acquired from the low-band filtering unit 250, to apply band-by-band energy of the clean signal (hereinafter, ‘CE’) estimated by the high-band energy estimator 240. Here, the high-band signal generator 260 may generate a clean high-band signal S′(f) by multiplying FFT frequency coefficient S(f) by a value of (CE/NE) per band, as represented by the following Equation 1.

S′(f)=S(f)*CE/NE (per band) [Equation 1]

The up-sampler 270 may generate a high-band signal by up-sampling the clean low-band signal generated by the noise suppressor 230.

The mixer 280 may generate a final high-band clean speech signal by mixing the high-band signal generated by the up-sampler 270 and the clean high-band signal generated by the high-band signal generator 260.

As described above, by generating a clean signal of a high band (a frequency band of 8˜24 kHz) using a clean signal of a low band (frequency band of 0˜8 kHz), an input/output size may be reduced in the deep learning model for inferring a clean speech and a clean high-band signal may be generated with fewer computations.

FIG. 3 is a diagram illustrating an example of a deep learning model according to some example embodiments. To estimate high-band energy 320 using a deep learning model 310, the high-band energy estimator 240 of FIG. 2 may perform a 512-point-FFT for a signal from which noise is removed and may calculate a magnitude value 330 for 256 frequency coefficients using an FFT coefficient value. Also, to infer the high-band energy 320, the high-band energy estimator 240 may input the calculated magnitude value 330 to the deep learning model 310.

The deep learning model 310 may be designed and trained to receive 256 low-band (frequency band of 0˜8 kHz) frequency magnitudes and to estimate 16 items (e.g., magnitudes) of high-band (frequency band of 8˜24 kHz) energy. Since a maximum (or highest) frequency of the low band and a maximum (or highest) frequency of the maximum (or highest) band differ from each other by three times, a number of samples for the same time length (or similar time lengths) may differ by three times. Therefore, in the case of the low band, a 512-point-FFT may be applied to 480 samples. In the case of the high band, a 2048-point-FFT may be applied to 1440 samples. Since the FFT is applied in units of 2 to an nth power, the 2048-point-FFT may be used for 1440 samples. According to psychoacoustical theory which indicates that a frequency resolution for recognizing sound is low in the high band, the deep learning model 310 may be designed to infer clean energy based on a band unit of 1 kHz. That is, a section of 16 kHz corresponding to 8˜24 kHz is divided into a total of 16 bands based on the band unit of 1 kHz. According to some example embodiments, the deep learning model 310 is trained using reference magnitude values corresponding to reference signals of the second band as input data. The reference magnitude values are associated (e.g., labeled) with reference estimated band-by-band energy of the third band (e.g., a determined/known accurate estimate and/or a determined/known inaccurate estimate). Accordingly to some example embodiments, training the deep learning model 310 may include sequentially inputting the reference magnitude values into the deep learning model 310, comparing estimated band-by-band energy items (e.g., magnitudes) output by the deep learning model 310 (e.g., output band-by-band energy) to the reference estimated band-by-band energy, and correcting the deep learning model 310 according to a difference between the output band-by-band energy and the reference band-by-band energy. Accordingly, the deep learning model 310 may be trained to output the reference estimated band-by-band energy when the reference magnitude value is input.

Also, with the assumption that a low-band signal input to train the deep learning model 310 is a clean speech signal, the deep learning model 310 is designed to infer clean high-band energy. To this end, a clean speech signal with a sampling rate of 16 kHz may be used as an input signal to be used to train the deep learning model 310, and band-by-band energy of a high band may be calculated for a clean speech signal with a sampling rate of 48 kHz and may be used as a label (target) of an output signal.

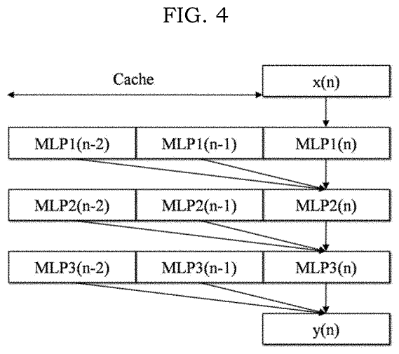

FIG. 4 illustrates an example of a structure of a network that infers clean energy in a frequency band of 8˜24 kHz according to some example embodiments. Here, in FIG. 4, x(n) represents a magnitude of a low band inferred as a clean signal in a current frame. Also, n denotes the current frame, n−1 denotes a previous first frame, and n−2 denotes a previous second frame (e.g., a frame previous to the previous first frame). The network of FIG. 4 may be implemented as a multi-layer perceptron (MLP) of five layers, and outputs (e.g., MLP1(n−1) and MLP1(n−2) for MLP1(n)) of the previous two frames may be cached in each layer and used as an input of a next frame. In the case of using such a network structure, many previous values may be referenced using a smaller deep learning model. Since a speech signal has continuity, the deep learning model with high accuracy may be generated with a fewer computations using a network that refers to previous values.

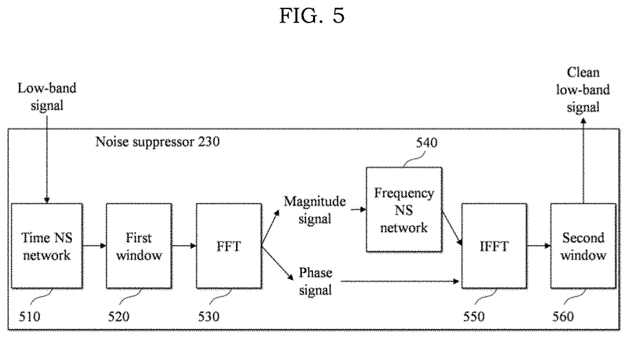

FIG. 5 illustrates an example of a process of removing noise from a signal of a low band (a frequency band of 0 to 8 kHz). FIG. 5 illustrates an example of a process of receiving, by the noise suppressor 230, a low-band signal and generating a clean low-band signal from which noise is removed. Here, the low-band signal may be a signal having a sampling rate of 16 kHz and a length of a single frame may be 480 samples. A hop size may operate with 50% overlap add to 240 samples.

To restore a phase of a speech signal in a strong noise environment and to primarily (e.g., initially) remove noise, a raw waveform of the low-band signal may be used as an input of a time noise suppressor (NS) network 510. The time NS network 510 may be a network designed in a u-net structure and may be implemented through an artificial neural network, for example, a convolutional neural network (CNN), a deep neural network (DNN), and/or Dense. For example, a size of each of a total of 12 layers may be configured to be a half of a size of a previous layer, such as 512-256-128-64-32-16-16-32-64-128-256-512. According to some example embodiments, only the u-net is used as a configuration of the time NS network 510 and details may vary depending on tuning. Output of the time NS network 510 is a raw first speech signal that is primarily (e.g., initially) estimated and a weak white noise component is mixed in the first speech signal.

Before performing an FFT 530 on the first speech signal, a first window 520 may be applied to improve an output characteristic of the FFT 530. Also, the first window 520 may be applied to remove (or reduce) noise caused by discontinuity in an overlap add section between a previous frame and a current frame. In FIG. 5, the first window 520 is applied before performing the FIT 530 and a second window 560 is applied after an IFFT 550. There are several types of applicable windows. For example, a Kaiser-Bessel-derived (KBD) window used for a time domain aliasing cancellation (TDAC) in a modified discrete cosine transform (MDCT) may be utilized. According to some example embodiments, a sum of squares of the KBD window satisfies 1 in the overlap section and thus, KBD windows, for example, the first window 520 and the second window 560 may be simultaneously (or contemporaneously) applied before the FFT 530 and after the IFFT 550, respectively. If windows are applied in two sections as above, noise caused by discontinuity between frames may be further effectively removed (or reduced). Improved performance is shown when applying the KBD window in actually implemented technology.

The FFT 530 may be performed on the first speech signal to which the first window 520 is applied. A magnitude signal representing a magnitude of the low-band signal and a phase signal representing a phase may be acquired from the first speech signal to which the FFT 530 is performed.

Here, in some example embodiments of FIG. 5, the noise suppressor 230 may restore, for example, a magnitude signal belonging to a frequency bandwidth of less than 8 kHz using a frequency NS network 540. A magnitude signal belonging to a bandwidth of 8 kHz or more may be divided based on a Bark scale unit, and average energy of the divided magnitude signal may be input to the frequency NS network 540 and used to restore the magnitude signal. Also, the phase signal may be used to perform the IFFT 550 without special processing (e.g., without use of a corresponding phase NS network). Also, Mel frequency cepstral coefficient(s) (MFCC(s)) generated based on the magnitude signal belonging to the bandwidth of less than 8 kHz may be input to the frequency NS network 540 as a parameter with the magnitude signal belonging to the bandwidth of less than 8 kHz. The frequency NS network 540 may be implemented in a u-net structure through an artificial neural network, for example, a CNN, a DNN, and/or Dense.

An output from the frequency NS network 540 may be a mask to be applied to a magnitude as an FFT coefficient output from the FFT 530. Using the magnitude to which the mask is applied and the phase signal as the FFT coefficient output from the FFT 530, noise may be secondarily (or subsequently) removed (or reduced). For example, using the magnitude to which the mask is applied and the phase signal, the FFT coefficient of the first speech signal may be restored and noise may be secondarily removed by performing the IFFT 550 and accordingly, the clean low-band signal may be output. Here, as described above, the second window 560 may be applied to an output of the IFFT 550 and noise caused by discontinuity between frames may be minimized (or reduced).

In some example embodiments, compared to a case of inputting a magnitude signal belonging to a frequency bandwidth of 8 kHz or more to the frequency NS network 540 as is, a computation amount used to remove noise may be significantly reduced using the magnitude signal belonging to the bandwidth of 8 kHz or more.

As described above, in some example embodiments, a network is configured in each of a frequency domain and a time domain for a signal of a low band (a frequency band of 0˜8 kHz) and the two networks are trained to perform in a mutually complementary manner and thus, improved noise reduction may be provided even in an environment with greater noise.

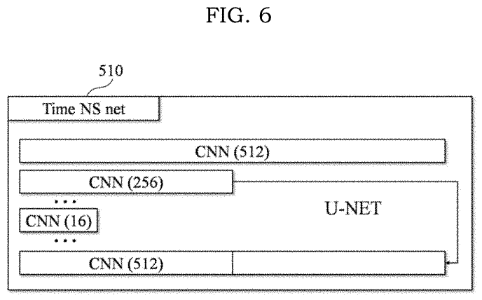

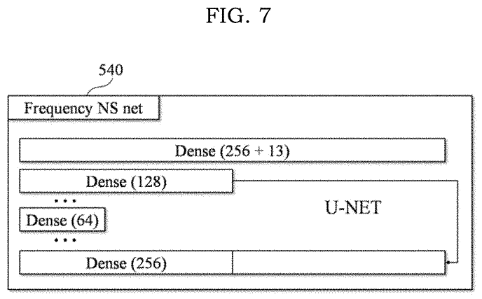

FIGS. 6 and 7 illustrate examples of a network in a u-net structure according to some example embodiments. Referring to FIG. 6, a u-net structure may be configured such that a size of each layer is a half of a size of a previous layer, such as 512-256-128-64-32-16-16-32-64-128-256-512, and a shape of the layers represents a “U.” FIG. 6 illustrates an example in which the time NS network 510 of FIG. 5 is implemented using a total of 12 layers of a CNN, and FIG. 7 illustrates an example in which the frequency NS network 540 of FIG. 5 is implemented using a total of six layers of Dense. However, it is provided as an example only of configuring the time NS network 510 and the frequency NS network 540.

Also, some example embodiments of FIGS. 5 to 7 are provided as examples only of a process of removing noise of a low-band signal and a method of removing noise of a low-band signal is not limited thereto. As described above, various technologies are developed for a signal having a sampling rate of 16 kHz.

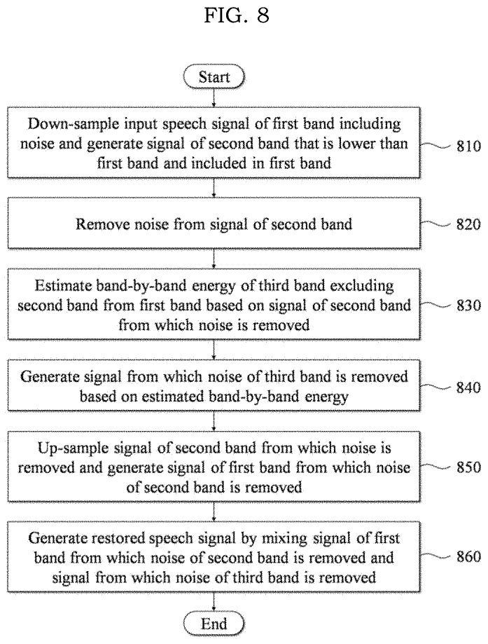

FIG. 8 is a flowchart illustrating an example of a noise reduction method according to some example embodiments. The noise reduction method of FIG. 8 may be performed by the computer device 100 of FIG. 1. Here, the processor 120 of the computer device 100 may be configured to execute a control instruction according to a code of at least one computer program, and/or a code of an OS, included in the memory 110. Here, the processor 120 may control the computer device 100 to perform operations 810 to 860 included in the noise reduction method of FIG. 8 according to the control instruction provided from a code stored in the computer device 100.

In operation 810, the computer device 100 may down-sample an input speech signal of a first band including noise and may generate a signal of a second band that is lower than the first band and included in the first band (e.g., the second band may be a lower portion of the first band). Here, the first band may include a frequency band of a full-band signal (a signal having a sampling rate of 48 kHz) and the second band may include a low band (a frequency band from 0 to less than 8 kHz).

In operation 820, the computer device 100 may remove (or reduce) noise from the signal of the second band. A method of removing (or reducing) noise from the signal of the second band is further described below.

In operation 830, the computer device 100 may estimate band-by-band energy of a third band (e.g., portion of the first band excluding the second band) from the first band based on the signal of the second band from which the noise is removed. Here, the third band may include a high band (a frequency band from 8 kHz to 48 kHz or less). For example, the computer device 100 may calculate a magnitude value for a frequency coefficient by applying an FFT to the signal of the second band from which the noise is removed, and may estimate the band-by-band energy of the third band using the calculated magnitude value and a deep learning model. Here, the deep learning model may be trained by using a magnitude value for the signal of the second band as input data and using the estimated band-by-band energy of the third band as a label and may be trained to output the band-by-band energy of the third band for the input magnitude value. For example, the deep learning model may be trained to receive 256 magnitude values as input and to output 16 items of band-by-band energy.

In operation 840, the computer device 100 may generate a signal from which noise of the third band is removed based on the estimated band-by-band energy. For example, the computer device 100 may generate a signal of the third band by removing the signal of the second band from the input speech signal of the first band using a high-pass filter and may calculate a frequency coefficient by applying an FFT to the generated signal of the third band. Also, the computer device 100 may calculate band-by-band energy of the generated signal of the third band, and may calculate the signal from which the noise of the third band is removed based on the estimated band-by-band energy, the calculated band-by-band energy, and the frequency coefficient. For example, the computer device 100 may generate a signal from which noise is removed (or reduced) for each band by applying a ratio of the calculated band-by-band energy of the estimated band-by-band energy to the frequency coefficient for each band (e.g., multiplying the frequency coefficient to a ratio of the calculated band-by-band energy to the estimated band-by-band energy for each band). Here, the frequency coefficient, the estimated band-by-band energy, and the calculated band-by-band energy may correspond to S(f), CE, and NE in Equation 1, respectively.

In operation 850, the computer device 100 may up-sample the signal of the second band from which the noise is removed and may generate the signal of the first band from which the noise of the second band is removed.

In operation 860, the computer device 100 may generate a restored speech signal by mixing the signal of the first band from which the noise of the second band is removed and the signal from which noise of the third band is removed. According to some example embodiments, the computer device 100 may transmit the restored speech signal to another device (e.g., via a network), convert the restored speech signal to an analog signal and control a speaker to vibrate air based on the analog signal to output audio signal corresponding to the restored speech signal, and/or store the restored speech signal.

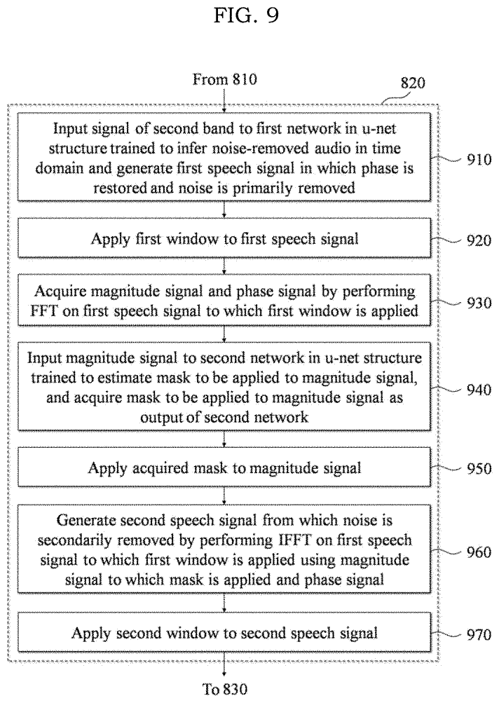

FIG. 9 is a flowchart illustrating an example of a process of removing noise from a signal of a low band according to some example embodiments. Operations 910 to 970 of FIG. 9 may be included in operation 820 of FIG. 8.

In operation 910, the computer device 100 may input the signal of the second band to a first network in a u-net structure trained to infer noise-removed speech in a time domain and may generate a first speech signal in which a phase is restored and noise is primarily (or initially) removed. Here, the signal of the second band may be the signal generated in operation 810 of FIG. 8 and the first network may correspond to the time NS network 510 of FIG. 5. As described above, the first network may be pre-trained (or trained) to restore a phase of the input speech signal and to primarily remove noise using the u-net structure of the time NS network 510. The first speech signal output in operation 910 may include a weak white noise component.

In operation 920, the computer device 100 may apply a first window to the first speech signal. As described above, although the first window may include a KBD window used for TDAC in MDCT, it is provided as an example only.

In operation 930, the computer device 100 may acquire a magnitude signal and a phase signal by performing an FFT on the first speech signal to which the first window is applied. For example, the computer device 100 may perform a 512 FFT on the first speech signal to which the first window is applied.

In operation 940, the computer device 100 may input the magnitude signal to a second network in a u-net structure trained to estimate a mask to be applied to the magnitude signal, and may acquire the mask to be applied to the magnitude signal as output of the second network. For example, the computer device 100 may extract a magnitude component from output of the 512 FFT and may use 256 pieces of magnitude data as input to the second network. Here, the second network may correspond to a machine learning model such as the frequency NS network 540 of FIG. 5 and may be trained to estimate the mask to be applied to the input magnitude signal.

The magnitude signal (and/or a parameter acquired from the corresponding magnitude signal) of the signal of the second band may be an input parameter to perform an inference in the second network.

In operation 950, the computer device 100 may apply the acquired mask to the magnitude signal. For example, the computer device 100 may acquire a magnitude signal from which noise of a frequency domain is removed by applying, for example, multiplying, the mask output by the second network to the magnitude signal of the first speech signal to which the first window is applied.

In operation 960, the computer device 100 may generate a second speech signal from which noise is secondarily (or subsequently) removed (or reduced) by performing an IFFT on the first speech signal to which the first window is applied using the magnitude signal to which the mask is applied and the phase signal.

In operation 970, the computer device 100 may apply a second window to the second speech signal. As described above, although the first window and the second window may include a KBD window used for TDAC in MDCT, it is provided as an example only. The first window and the second window may be used to minimize (or reduce) noise caused by discontinuity between frames by performing a frame-based operation to apply real-time technology to an input speech signal in a mobile environment.

Some example embodiments of FIG. 9 refer to examples of removing noise from a signal of a low band and a method of removing noise from a signal of a low band is not limited to these examples. As described above, various technologies are developed for a signal having a sampling rate of 16 kHz.

Here, according to some example embodiments, it is possible to reduce an input/output size of a deep learning model by removing noise from a signal of a second band that is a low band and by removing noise from a signal of a third band that is a high band through the deep learning model based on the signal of the second band from which the noise is removed, and to generate a clean high-band signal with fewer computations.

Conventional devices for reducing noise in a signal apply deep learning to signals having a sampling rate of 16 kHz. Such conventional devices experience excessive delay and resource consumption (e.g., power, processor, etc.) when performing noise reduction on a full band signal (e.g., a signal having a sampling rate of 48 kHz) due to a higher number of computations when applying the deep learning in connection with this larger input signal and/or output signal (e.g., broader bandwidth, more samples, etc.). Accordingly, the conventional devices are unsuitable for real-time signaling, such as VoIP services.

However, according to some example embodiments, improved devices are provided for reducing noise in a signal. For example, the improved devices remove noise from a lower band portion of the signal, and remove noise from a higher band portion of the signal using a deep learning model based on the lower band portion in which the noise is removed. Accordingly, the deep learning model of the improved devices performs fewer computations due to a smaller input signal and/or output signal (e.g., narrower bandwidth, fewer samples, etc.) associated with the higher band portion (in comparison to the entire signal). Thus, the improved devices overcome the deficiencies of the conventional devices to at least reduce delay and resource consumption (e.g., power, processor, etc.). Also, the improved devices are more suitable than the conventional devices for real-time signaling, such as VoIP services in view of the above improvements.

According to some example embodiments, operations described herein as being performed by the computer device 100, the processor 120, the communication interface 130, the I/O interface 140, the down-sampler 220, the noise suppressor 230, the high-band energy estimator 240, the low-band filtering unit 250, the high-band signal generator 260, the up-sampler 270, the mixer 280, the deep learning model 310, the time NS network 510 and/or the frequency NS network 540 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In some example embodiments, the processing circuitry may perform some operations (e.g., the operations described herein as being performed by the deep learning model 310, the time NS network 510 and/or the frequency NS network 540) by artificial intelligence and/or machine learning. As an example, the processing circuitry may implement an artificial neural network that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

The systems and/or the apparatuses described above may be implemented using hardware components, software components, and/or a combination thereof. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The above-described methods according to some example embodiments may be configured in a form of program instructions performed through various computer devices and recorded in non-transitory computer-readable media (e.g., the memory 110). The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software. Examples of a program instruction may include a machine language code produced by a compiler and a high-language code executable by a computer using an interpreter.

While this disclosure includes some example embodiments, it will be apparent to one of ordinary skill in the art that various alterations and modifications in form and details may be made without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A noise reduction method performed by a computer device comprising at least one processor, the noise reduction method comprising:
down-sampling, by the at least one processor, a first signal of a first band to obtain a first signal of a second band, the first signal of the first band being an input speech signal including noise, and the second band being a lower portion of the first band;
removing, by the at least one processor, noise from the first signal of the second band to obtain a second signal of the second band;
estimating, by the at least one processor, band-by-band energy of a third band based on the second signal of the second band to obtain estimated band-by-band energy, the third band being a portion of the first band remaining after excluding the second band; and
generating, by the at least one processor, a signal from which noise of the third band is removed based on the estimated band-by-band energy.

2. The noise reduction method of claim 1, wherein the estimating of the band-by-band energy of the third band comprises:
calculating a magnitude value for a frequency coefficient by applying a fast Fourier transform (FFT) to the second signal of the second band to obtain a calculated magnitude value; and
estimating the band-by-band energy of the third band using the calculated magnitude value and a deep learning model.

3. The noise reduction method of claim 2, wherein the deep learning model is trained by using a reference magnitude value for a reference signal of the second band as input data and using a reference estimated band-by-band energy of the third band as a label, the deep learning model being trained to output the reference estimated band-by-band energy when the reference magnitude value is input.

4. The noise reduction method of claim 2, wherein the deep learning model is trained to receive 256 magnitude values as input and to output 16 band-by-band energy magnitudes.

5. The noise reduction method of claim 1, wherein
the generating of the signal from which the noise of the third band is removed comprises:
generating a signal of the third band by removing the first signal of the second band from the first signal of the first band using a high-pass filter;
calculating a frequency coefficient by applying an FFT to the signal of the third band;
calculating band-by-band energy of the signal of the third band to obtain calculated band-by-band energy; and
calculating the signal from which the noise of the third band is removed based on the estimated band-by-band energy, the calculated band-by-band energy, and the frequency coefficient.

6. The noise reduction method of claim 5, wherein the calculating of the signal from which the noise of the third band is removed comprises:
generating a signal from which noise is removed for each band by multiplying the frequency coefficient to a ratio of the calculated band-by-band energy to the estimated band-by-band energy.

7. The noise reduction method of claim 1, further comprising:
up-sampling, by the at least one processor, the second signal of the second band to obtain a second signal of the first band from which the noise of the second band is removed; and
generating, by the at least one processor, a restored speech signal by mixing the second signal of the first band and the signal from which the noise of the third band is removed.

8. The noise reduction method of claim 1, wherein the first band includes a frequency band of a corresponding signal having a sampling rate of 48 kHz, the second band includes a frequency band from 0 to less than 8 kHz, and the third band includes a frequency band from 8 kHz to 24 kHz or less.

9. The noise reduction method of claim 1, wherein the removing of the noise from the first signal of the second band comprises:
inputting the first signal of the second band to a first network to obtain a first speech signal in which a phase is restored and noise is removed, the first network being a u-net structure trained to infer noise-removed speech in a time domain;
applying a first window to the first speech signal;
acquiring a magnitude signal and a phase signal by performing an FFT on the first speech signal to which the first window is applied;
inputting the magnitude signal to a second network to acquire a mask, the second network being a u-net structure trained to estimate the mask;
applying the mask to the magnitude signal to obtain a masked magnitude signal;
generating a second speech signal from which noise is removed by performing an inverse fast Fourier transform (IFFT) on the first speech signal to which the first window is applied using the masked magnitude signal t and the phase signal; and
applying a second window to the second speech signal.

10. A non-transitory computer-readable record medium storing an instruction that, when executed by at least one processor included in a computer device, causes the computer device to perform the noise reduction method of claim 1.

11. The noise reduction method of claim 1, further comprising:
generating a restored speech signal based on the signal from which noise of the third band is removed; and
performing one of,
transmitting the restored speech signal to another device,
vibrating air to output an audio signal based on the restored speech signal using a speaker, or
storing the restored speech signal.

12. The noise reduction method of claim 1, wherein the input speech signal is a Voice over Internet Protocol (VoIP) signal.

13. A computer device comprising:
at least one processor configured to execute a computer-readable instruction to,
down-sample a first signal of a first band to obtain a first signal of a second band, the first signal of the first band being an input speech signal including noise, and the second band being a lower portion of the first band,
remove noise from the first signal of the second band to obtain a second signal of the second band,
estimate band-by-band energy of a third band based on the second signal of the second band to obtain estimated band-by-band energy, the third band being a portion of the first band remaining after excluding the second band, and
generate a signal from which noise of the third band is removed based on the estimated band-by-band energy.

14. The computer device of claim 13, wherein the at least one processor is configured to execute a computer-readable instruction to estimate the band-by-band energy of the third band by,
calculating a magnitude value for a frequency coefficient by applying a fast Fourier transform (FFT) to the second signal of the second band to obtain a calculated magnitude value; and
estimating the band-by-band energy of the third band using the calculated magnitude value and a deep learning model.

15. The computer device of claim 13, wherein the at least one processor is configured to execute a computer-readable instruction to generate the signal from which the noise of the third band is removed by,
generating a signal of the third band by removing the first signal of the second band from the first signal of the first band using a high-pass filter;
calculating a frequency coefficient by applying an FFT to the signal of the third band;
calculating the band-by-band energy of the signal of the third band to obtain calculated band-by-band energy; and
calculating the signal from which the noise of the third band is removed based on the estimated band-by-band energy, the calculated band-by-band energy, and the frequency coefficient.

16. The computer device of claim 15, wherein the at least one processor is configured to execute a computer-readable instruction to calculate the signal from which the noise of the third band is removed by generating a signal from which noise is removed for each band by multiplying the frequency coefficient to a ratio of the calculated band-by-band energy to the estimated band-by-band energy.

17. The computer device of claim 13, wherein the at least one processor is configured to cause the computer device to,
up-sample the second signal of the second band to obtain a second signal of the first band from which the noise of the second band is removed; and
generate a restored speech signal by mixing the second signal of the first band and the signal from which the noise of the third band is removed.

18. The computer device of claim 13, wherein the at least one processor is configured to execute a computer-readable instruction to remove the noise from the first signal of the second band by,
inputting the first signal of the second band to a first network to obtain a first speech signal in which a phase is restored and noise is removed, the first network being a u-net structure trained to infer noise-removed speech in a time domain;
applying a first window to the first speech signal;
acquiring a magnitude signal and a phase signal by performing an FFT on the first speech signal to which the first window is applied;
inputting the magnitude signal to a second network to acquire a mask. the second network being a u-net structure trained to estimate the mask;
applying the mask to the magnitude signal to obtain a masked magnitude signal;
generating a second speech signal from which noise is removed by performing an inverse fast Fourier transform (IFFT) on the first speech signal to which the first window is applied using the masked magnitude signal t and the phase signal; and
applying a second window to the second speech signal.

19. The computer device of claim 13, wherein the at least one processor is configured to cause the computer device to,
generate a restored speech signal based on the signal from which noise of the third band is removed; and
perform one of,
transmitting the restored speech signal to another device,
vibrating air to output an audio signal based on the restored speech signal using a speaker, or
storing the restored speech signal.

20. The computer device of claim 13, wherein the input speech signal is a Voice over Internet Protocol (VoIP) signal.
